(19) United States
(12) Patent Application Publication
(10) Pub. No.: US 2005/0270716 A1
(43) Pub. Date: Dec. 8, 2005

(54) Hybrid relay

(75) Inventor: Tsunehiko Nakano, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: JAMCO CORPORATION, Tokyo (JP)

(21) Appl. No.: 11/127,257

(22) Filed: May 12, 2005

(30) Foreign Application Priority Data
Jun. 7, 2004 (JP) 2004-168015

(51) Int. Cl. H02H 3/00

(52) U.S. Cl. 361/103

(57) ABSTRACT

The invention provides a hybrid relay generating low electric noise used for controlling the on/off of an electrical equipment. A hybrid relay 30 inserted to a line L supplying power to a load 20 has lines L₁ and L₂ branched in parallel. A first mechanical relay 31 is inserted to the first line L₁, and a semiconductor relay 33 and a second mechanical relay 32 are inserted serially to the second line L₂. When turned on, the second mechanical relay 32 is closed, the semiconductor relay 33 is closed, and then the first mechanical relay 31 is closed, and finally the semiconductor relay 33 is opened. When turned off, the opposite operation is carried out. The semiconductor relay will not always be closed, and the generation of electric noises by the mechanical relay can be prevented.

The present application is based on and claims priority of Japanese patent application No. 2004-168015 filed on Jun. 7, 2004, the entire contents of which are hereby incorporated by reference.

### BACKGROUND OF THE INVENTION

1. Field of the Invention

The present invention relates to a hybrid relay used for controlling the temperature of electrical equipments, and especially relates to a hybrid relay preferably adopted for controlling equipments that are turned on and off frequently, such as for controlling the temperature of electrical equipments on aircrafts.

2. Description of the Related Art

Since relays used on aircrafts are required to be highly safe and reliable, to have advantageous electric noise performance, and to be capable of operating by the power supply on the aircraft, it is difficult to apply a semiconductor relay, in other words, a solid state relay (SSR), used widely in the field of general commercial appliances.

The conventionally used mechanical relays incorporate electric contacts, which tend to generate arc when being turned on and off, causing problems such as the welding of contacts or the occurrence of electric noises.

Mechanical relays are often used to control the temperature of electrical equipments for cooking used on board an aircraft, such as ovens and coffee makers, which are subjected to frequent on/off operation, according to which the occurrence of electric noises becomes a problem. Thus, measures are taken against electric noises, such as the application of noise filters. Semiconductor relays (SSR) are used to be facilitated not to have such drawbacks since they do not use electric contacts. However, since they use semiconductors, the internal resistance when the relay is turned on is greater compared to the contact - type relays, so they have other drawbacks, such as the generation of higher heat or the minute electric current flowing therethrough even during the off status.

Hybrid relays are disclosed for example in WO9742642, published in Japan as Patent Application Laid-Open Publication No. 2000-509547.

### SUMMARY OF THE INVENTION

The present invention provides a hybrid relay combining a mechanical relay and a semiconductor relay (SSR), which is especially preferable for equipments like controlling the temperature of electrical equipments on an aircraft by frequent on/off switching.

The hybrid relay according to the present invention inserted to a power supply line between a power supply and a load comprises, as basic means, a first line and a second line which are branched in parallel, a first mechanical relay inserted to the first line, and a semiconductor relay and a second mechanical relay inserted serially to the second line.

According to a further aspect of the invention, the operation during which the hybrid relay is turned from off to on comprises closing the second mechanical relay of the second line, closing the semiconductor relay, closing the first mechanical relay of the first line, and opening the semiconductor relay of the second line.

According to a further aspect of the invention, the operation during which the hybrid relay is turned from on to off comprises closing the semiconductor relay of the second line, opening the first mechanical relay of the first line, opening the semiconductor relay of the second line, and opening the second mechanical relay of the second line.

The following effects are achieved by the hybrid relay of the present invention.

The electric noises can be minimized by effectively utilizing a zero cross circuit of the SSR.

The welding of contacts can be solved by utilizing the SSR having no contacts.

Current leakage can be solved by utilizing mechanical relays.

Heat generation can be minimized by utilizing mechanical relays.

Regarding failure mode, the circuit can be opened even during failure of the SSR, by adopting two types of contacts, which are the mechanical relay and the solid state relay.

### BRIEF DESCRIPTION OF THE DRAWINGS

FIG. 1 is an electric circuit diagram adopting the hybrid relay according to the present invention;

FIG. 2 is a block diagram showing the hybrid relay according to the present invention; and

FIG. 3 is an explanatory view showing the operation of the hybrid relay according to the present invention.

### DETAILED DESCRIPTION OF THE PREFERRED EMBODIMENTS

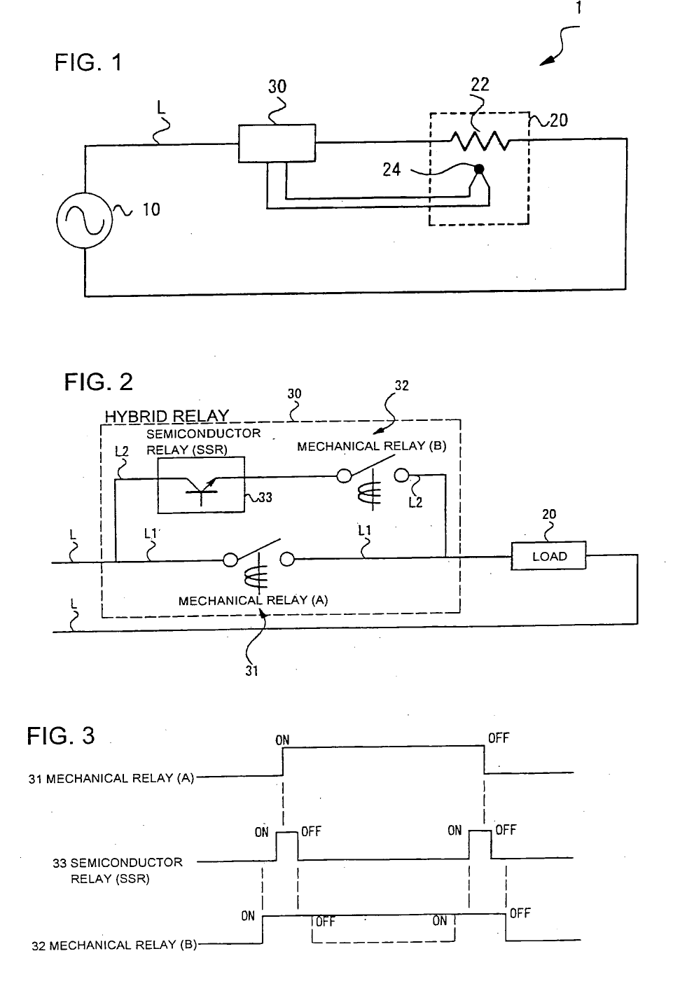

FIG. 1 is an explanatory view showing one example of an electric circuit adopting the hybrid relay according to the present invention.

An electric circuit, the whole of which being denoted by reference number 1, is formed by connecting a power supply 10, a load 20 and a hybrid relay 30 by a line L, which can be applied, for example, to electrical equipments on board an aircraft.

The power supply 10 on an aircraft can utilize, for example, a power supply with a frequency of 400 Hz, capable of outputting 115 V as single phase voltage and 200 V as three phase voltage.

The load 20 can be, for example, a cooking equipment such as an electric oven, a coffee maker or a water heater, which is equipped with an electric heater 22 and a temperature sensor 24. The signals from the temperature sensor 24 will be sent to the hybrid relay 30, controlling the on/off of the current flowing in the power supply line leading to the load 20.

FIG. 2 is an explanatory view showing the details of the hybrid relay according to the present invention.

The hybrid relay 30 includes a first line L₁ and a second line L₂, which are formed by dividing and branching a power supply line L connecting the power supply and the load 20 into parallel lines.

A first mechanical relay (A) denoted by reference number 31 is incorporated in the first line L₁.

A semiconductor relay (SSR) 33 and a second mechanical relay (B) denoted by reference number 32 are serially incorporated in the second line L₂.

Next, the operation of the hybrid relay according to the present invention will be described.

FIG. 3 is a time chart showing the operation of the hybrid relay that is turned from off to on.

[Turning from Off to On]

(1) First, the second mechanical relay (B) 32 of line L₂ is closed. At this time, the semiconductor relay 33 is opened and no current flows through line L₂, according to which no electric noise is generated when the mechanical relay 32 is closed.

(2) Then, the semiconductor relay 33 is closed. Thereby, current flows toward the load 20 via the line L₂. Since the closing of the semiconductor relay 33 is performed by zero cross, the noise generated by this operation can be held down to a minimum.

(3) Next, the first mechanical relay (A) 31 of line L₁ is closed. At this time, there are no potential differences between the input and output contacts of the mechanical relay (A), so no electric noise will be generated when the relay is closed.

(4) Finally, the semiconductor relay 33 is opened. Since no current flows through line L₂ of the semiconductor relay 33, the semiconductor relay 33 will not generate heat.

Incidentally, the second mechanical relay 32 can be opened after opening the semiconductor relay 33.

[Turning from On to Off]

(1) At first, the semiconductor relay 33 is closed. Current flows toward the load 20 via lines L₁ and L₂ in parallel. Since the closing of the semiconductor relay 33 is performed by zero cross, the electric noise generated by this operation can be held down to a minimum.

At this time, if the second mechanical relay 32 is opened, it is closed in advance.

(2) The first mechanical relay (A) 31 of the first line is opened. Line L₂ is closed, and there are no potential differences between the input and output terminals of the relay, so no electric noise will be generated when the first mechanical relay (A) is opened.

(3) The semiconductor relay 33 is opened. Since this is performed by zero cross, the electric noise generated by this operation can be held down to a minimum.

(4) The second mechanical relay (B) 32 of the second line L₂ is opened. Since the line L₂ is opened mechanically, there will be no generation of minute leak current flowing through the semiconductor circuit of the SSR.

Since the hybrid relay according to the present invention operates as described above, a desirable circuit with no drawbacks such as heat generation, electric noise and current leak can be arranged by utilizing the features of both the mechanical relay and the semiconductor relay (SSR), as shown in Table 1.

TABLE 1
Features of Mechanical Relay and Semiconductor Relay (SSR)

| Items | Mechanical Relay | Semiconductor Relay (SSR) |
|---|---|---|
| Electric | Electric noise is | Noise can be minimized by |
| Noise | generated at | adopting a zero cross circuit. |
| | contact during | |
| | on/off. | |
| Welding of | Mechanical | Since there is no contact, the |
| Contact | contact tends to | problem of welding of contact |
| | generate arc | will not occur. |
| | during on/off, | |
| | which can cause | |
| | welding of | |
| | contact. | |
| Heat | Since resistance | Heat is generated by internal |
| Generation | at contact is | resistance of the semiconductor |
| | small, the heat | device, and heat will increase |
| | generated during | when the load current increases. |
| | on status is small. | Therefore, it is necessary to |
| | | provide a heat release mechanism |
| | | such as a heat sink. |
| Current | Since mechanical | The contact utilizes change in |
| Leak | contact is used, | resistance of the |
| | current leak | semiconductor, so minute |
| | during off status | current leak occurs during off |
| | is basically zero. | status. |
| Failure | Except for welding | During failure, the contact is |
| Mode | of contact, it can | basically closed. |
| | be at off status | |
| | during failure. | |

1. A hybrid relay inserted to a power supply line between a power supply and a load, the hybrid relay comprising:
a first line and a second line which are branched in parallel;
a first mechanical relay inserted to the first line; and
a semiconductor relay and a second mechanical relay inserted serially to the second line.

2. The hybrid relay according to claim 1, wherein the operation during which the hybrid relay is turned from off to on comprises:
closing the second mechanical relay of the second line;
closing the semiconductor relay;
closing the first mechanical relay of the first line; and
opening the semiconductor relay of the second line.

3. The hybrid relay according to claim 1, wherein the operation during which the hybrid relay is turned from on to off comprises:
closing the semiconductor relay of the second line;
opening the first mechanical relay of the first line;
opening the semiconductor relay of the second line; and
opening the second mechanical relay of the second line.

4. The hybrid relay according to claim 1, wherein the power supply is a power supply equipped in an aircraft, and the load can be, for example, a cooking equipment equipped with an electric heater and a temperature sensor.
